(19) United States
(12) Patent Application Publication
(10) Pub. No.: US 2016/0307131 A1
(43) Pub. Date: Oct. 20, 2016

(54) METHOD, APPARATUS, AND SYSTEM FOR CONTROLLING DELIVERY TASK IN SOCIAL NETWORKING PLATFORM

(71) Applicant: TENCENT TECHNOLOGY (SHENZHEN) COMPANY LIMITED, Shenzhen, Guangdong (CN)

(72) Inventors: Hui WANG, Shenzhen (CN); Li LIU, Shenzhen (CN)

(73) Assignee: TENCENT TECHNOLOGY (SHENZHEN) COMPANY LIMITED, Shenzhen, Guangdong (CN)

(21) Appl. No.: 15/101,649

(22) PCT Filed: Apr. 17, 2015
(86) PCT No.: PCT/CN2015/076852

§ 371 Date: Jun. 3, 2016

(30) Foreign Application Priority Data
Apr. 17, 2014 (CN) 201410155956.9

(51) Int. Cl. G06Q 10/06

(52) U.S. Cl. CPC G06Q 10/06311; G06Q 10/06316; G06Q 50/01

(57) ABSTRACT

The present disclosure discloses a method, an apparatus, and a system for controlling a delivery task in a social networking platform. The method includes: obtaining a user group to which a delivery task is to be released in a targeted manner, the user group including one or more users, and the user group to which the delivery task is to be released in a targeted manner being determined according to targeting information and/or a user characteristic weight value, which are recorded in a task database, of the delivery task; obtaining task data of the delivery task; adding the delivery task and the task data of the delivery task to a delivery task list for each user included in the user group; and accessing the delivery task list after any user in the user group logs in to a social networking platform, and pushing the task data of the delivery task to the user. By using the present disclosure, accurate targeted pushing of a delivery task can be ensured, thereby preventing a waste of resources of the delivery task.

### FIELD OF THE TECHNOLOGY

The present disclosure relates to the computer Internet field, and in particular, to a method, an apparatus, and a system for controlling a delivery task in a social networking platform.

### BACKGROUND OF THE DISCLOSURE

User generated content (UGC for short), also referred to as user created content, is a new manner for using the Internet by users, which attaches equal importance to both downloading and uploading in replacement of the original manner that is mainly based on downloading. Community networks, video sharing, and blogs are all main application forms of UGC. Especially with diversification of intelligent terminals and the continuous development of global Internet services, UGC services increase day by day, drawing widespread attention in the field.

Therefore, with the rapid development of social networks of the Internet, on a social networking platform, delivery tasks that are generated by users and pushed between network users are increasing exponentially. For example, because data of UGC is generated by a user, and massive users generate massive data, there are a large number of data read and/or write requests for interaction on a social networking platform. Delivery data of such massive delivery tasks easily put users in an ocean of information. While enjoying beneficial information brought by these delivery tasks, users are also harassed by information.

For example, if a delivery task is an advertisement to be delivered in a targeted manner, a present system may push advertisement information to users in a social networking platform. Because the advertisement is pushed in a broadcast style in this case, although a requirement of an advertiser for promotion is satisfied, the advertisement may be harassing information for a user receiving the advertisement; and disturbed by the information, the user cannot obtain advertisement information that the user really needs.

For the foregoing problem of inaccurate pushing of a delivery task in a social networking platform in the existing technology, no effective solution is provided yet at present.

### SUMMARY

Embodiments of the present invention provide a method, an apparatus, and a system for controlling a delivery task in a social networking platform, to at least solve a technical problem of inaccurate pushing of a delivery task in a social networking platform in the existing technology.

According to an aspect of an embodiment of the present invention, a method for controlling a delivery task in a social networking platform is provided. The method includes: obtaining a user group to which a delivery task is to be released in a targeted manner, the user group including one or more users, and the user group to which the delivery task is to be released in a targeted manner being determined according to targeting information and/or a user characteristic weight value, which are recorded in a task database, of the delivery task; obtaining task data of the delivery task; adding the delivery task and the task data of the delivery task to a delivery task list for each user included in the user group; and accessing the delivery task list after any user in the user group logs in to a social networking platform, and pushing the task data of the delivery task to the user.

According to another aspect of an embodiment of the present invention, a system for controlling a delivery task in a social networking platform is further provided. The system includes: a user server, configured to save a user group to which a delivery task is to be released in a targeted manner, the user group including one or more users, and the user server determining the user group, to which the delivery task is to be released in a targeted manner, according to targeting information and/or a user characteristic weight value, which are recorded in a task database, of the delivery task; a delivery task server, configured to save task data of the delivery task; and a delivery control server, having a communication relationship with the user server and the delivery task server, and configured to add the delivery task and the task data of the delivery task to a delivery task list for each user included in the user group after the user group to which the delivery task is to be released in a targeted manner and the task data of the delivery task are obtained, access the delivery task list after any user in the user group logs in to a social networking platform, and push the task data of the delivery task to the user.

According to still another aspect of an embodiment of the present invention, an apparatus for controlling a delivery task in a social networking platform is further provided. The apparatus includes: a first obtaining module, configured to obtain a user group to which a delivery task is to be released in a targeted manner, the user group including one or more users, and the user group to which the delivery task is to be released in a targeted manner being determined according to targeting information and/or a user characteristic weight value, which are recorded in a task database, of the delivery task; a second obtaining module, configured to obtain task data of the delivery task; an adding module, configured to add the delivery task and the task data of the delivery task to a delivery task list for each user included in the user group; and a pushing module, configured to access the delivery task list after any user in the user group logs in to a social networking platform, and push the task data of the delivery task to the user.

In the embodiments of the present invention, a user group to which a delivery task is to be released in a targeted manner is obtained, the user group including one or more users, and the user group to which the delivery task is to be released in a targeted manner being determined according to targeting information and/or a user characteristic weight value, which are recorded in a task database, of the delivery task; task data of the delivery task is obtained; the delivery task and the task data of the delivery task are added to a delivery task list for each user included in the user group; and the delivery task list is accessed after any user in the user group logs in to a social networking platform, and the task data of the delivery task is pushed to the user. In this way, before a current delivery task is delivered, a user group to which the delivery task needs to be sent in a targeted manner is first determined according to information of the current delivery task, and then the delivery task is added to a task list of a user in the user group. Therefore, once the user in the user group logs in, a system automatically pushes the delivery task according to a record in the delivery task list, so that an objective of accurate targeted pushing of a delivery task without wasting resources of the delivery task is achieved. Therefore, a technical effect that for a user receiving the delivery task, the obtained delivery task is content that satisfies a need of the user is achieved, thereby solving a technical problem of inaccurate pushing of a delivery task in a social networking platform in the existing technology.

### BRIEF DESCRIPTION OF THE DRAWINGS

The accompanying drawings described herein are used to provide a further understanding of the present disclosure, and constitute a part of this application. Exemplary embodiments of the present invention and descriptions thereof are used for explaining the present disclosure, and do not constitute improper limitations on the present disclosure.

FIG. 1 is a flowchart of a method for controlling a delivery task in a social networking platform according to Embodiment 1 of the present invention;

FIG. 2 is a schematic functional frame diagram of an optional method for controlling a delivery task in a social networking platform according to Embodiment 1 of the present invention;

FIG. 3 is a schematic detailed diagram of an optional method for controlling a delivery task in a social networking platform according to Embodiment 1 of the present invention;

FIG. 4 is a schematic structural diagram of a system for controlling a delivery task in a social networking platform according to Embodiment 2 of the present invention;

FIG. 5 is a schematic structural diagram of an apparatus for controlling a delivery task in a social networking platform according to Embodiment 3 of the present invention;

FIG. 6 is a schematic structural diagram of an optional apparatus for controlling a delivery task in a social networking platform according to Embodiment 3 of the present invention;

FIG. 7 is a schematic structural diagram of another optional apparatus for controlling a delivery task in a social networking platform according to Embodiment 3 of the present invention; and

FIG. 8 is a schematic structural diagram of still another optional apparatus for controlling a delivery task in a social networking platform according to Embodiment 3 of the present invention.

### DESCRIPTION OF EMBODIMENTS

To order that a person skilled in the art better understands solutions of the present disclosure, the following clearly and completely describes the technical solutions in embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present disclosure.

It should be noted that the terms such as “first” and “second” in the specification and claims of the present disclosure and the foregoing accompanying drawings are used to differentiate similar objects, and are not used to describe a particular sequence or chronological order. It should be understood that data used in this way can be interchanged under appropriate circumstances, so that the embodiments described herein of the present invention can be implemented in another order except those shown in the drawings or descriptions. Moreover, the terms “include”, “having”, and any variants thereof are intended to cover a non-exclusive inclusion. For example, a process, method, system, product, or device including a series of steps or units is not necessarily limited to those steps or units clearly listed, but may include another step or unit that is not listed clearly or is inherent to the process, method, system, product, or device.

It needs to be noted herein that grayscale involved in this application refers to a strategy in which a new system or a new method is gradually made available to users to verify robustness of the new system or new method.

### Embodiment 1

According to an embodiment of the present invention, a method embodiment may be provided. It should be noted that steps shown in a flowchart in an accompanying drawing may be performed, for example, in a computer system with a set of computer executable instructions, and although a logical order is shown in the flowchart, the shown or described steps may be performed in an order different from the order herein in some cases.

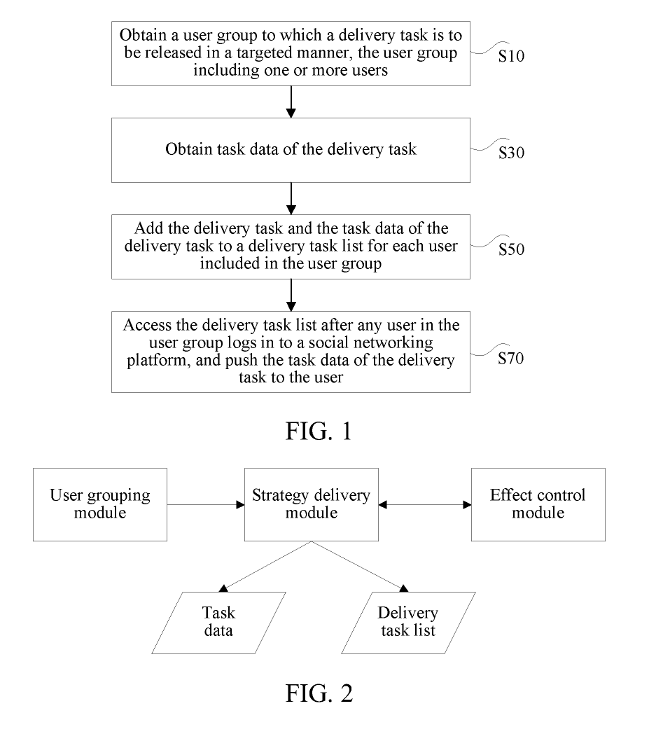

FIG. 1 is a flowchart of a method for controlling a delivery task in a social networking platform according to Embodiment 1 of the present invention. As shown in FIG. 1, the method may include the following steps:

Step S10: Obtain a user group to which a delivery task is to be released in a targeted manner, the user group including one or more users, and the user group to which the delivery task is to be released in a targeted manner being determined according to targeting information and/or a user characteristic weight value, which are recorded in a task database, of the delivery task.

Step S30: Obtain task data of the delivery task.

Step S50: Add the delivery task and the task data of the delivery task to a delivery task list for each user included in the user group.

Step S70: Access the delivery task list after any user in the user group logs in to a social networking platform, and push the task data of the delivery task to the user.

In Embodiment 1 of this application, before a current delivery task is delivered, a user group to which the delivery task needs to be sent in a targeted manner is first determined according to information of the current delivery task, and then the delivery task is added to a task list of a user in the user group. Therefore, once the user in the user group logs in, a system automatically pushes the delivery task according to a record in the delivery task list. It can be known that the delivery task pushed on a current social networking platform is pushed to the corresponding user group in a targeted manner. It is noticeable that because the target user group is obtained through screening according to targeting information and/or a user characteristic weight value, which are recorded in a task database, of the delivery task, the current delivery task is accurately pushed to the matching user group, and users in the user group do not change dynamically. Therefore, by using the solution provided by this embodiment of the present invention, potential information of users in a social networking platform is dug up, so as to predict a user to which a current delivery task needs to be pushed. Such a manner for accurately pushing a delivery task implements accurate targeted pushing of a delivery task, thereby preventing a waste of resources of the delivery task. In addition, for a user receiving the delivery task, the obtained delivery task is content that satisfies a need of the user. Therefore, a technical problem of inaccurate pushing of a delivery task in a social networking platform in the existing technology is solved, and accurate targeted pushing of a delivery task is implemented.

Step S10 to step S70 provided by the foregoing embodiment of this application may be run in a social networking platform server, and may be implemented by a strategy delivery module in an embodiment shown in FIG. 2. For optional or preferred embodiments provided by the present disclosure, the embodiments may be further described in detail by using targeted pushing of an advertisement in a microblog as an example. In this case, the social networking platform may be a microblog; the delivery task may be an advertisement; the task data may be advertisement task information that is already saved, and may include a delivery time period and a delivering terminal of a delivery object and a quantity of people to which the delivery object is already delivered; and the delivery task list may be an advertisement task list, and is used to save delivery data of each user in a user group, that is, an advertising link that should be delivered to a user.

It can be known with reference to FIG. 2 that in the foregoing embodiment of this application, an independent user grouping module may also be used to implement step S10, and the solution of determining the user group, to which the delivery task is to be released in a targeted manner, according to targeting information and/or a user characteristic weight value, which are recorded in a task database, of the delivery task in this step may include the following implementation manners:

The first manner: First obtain the targeting information of the delivery task from the task database, where the targeting information includes characteristic information of a delivery object; and then perform matching processing in a user group information base according to the characteristic information of the delivery object, and obtain a first user group having the characteristic information of the delivery object, where the first user group having the characteristic information of the delivery object forms the user group to which the delivery task is to be released in a targeted manner.

The foregoing solution provided by an optional embodiment implements accurate screening of a push target of the delivery task that needs to be pushed currently, and the task database may be built on a task server that runs independently. In an application scenario in which a microblog is used as an example, an advertisement task may be first obtained from a list in an advertisement task database; at the same time, a follower sub-circle (a friend group of a microblog user) obtains related targeting information, such as a push primary account number and characteristics of people for advertising promotion (for example, professions of users), of the advertisement task; and followers that meet a requirement are obtained through calculation. In this way, according to a characteristic of push target users required by advertising promotion, a group of users that meet the characteristic are selected from chosen microblog primary account numbers, thereby obtaining a user group (a follower group of a microblog) for targeted advertisement pushing.

The second manner: First obtain the targeting information of the delivery task from the task database, where the targeting information includes characteristic information of a delivery object; then perform matching processing in a user group information base according to the characteristic information of the delivery object, and obtain a first user group having the characteristic information of the delivery object; and then select a user of which a characteristic weight value is greater than a preset threshold from the first user group, to generate the user group to which the delivery task is to be released in a targeted manner. In this process, before users are selected, users in the first user group may be sorted according to characteristic weight values of the users.

The foregoing solution provided by another optional embodiment also implements accurate screening of a push target of the delivery task that needs to be pushed currently. Compared with the first manner, the second manner further limits a screening condition, and the screen condition not only includes targeting information of an advertisement task but also includes a user characteristic weight value. In this way, a quantity of users receiving a pushed advertisement is further limited, so that the current advertisement is pushed accurately and efficiently. It can be known through the foregoing analysis that in the foregoing two optional embodiments, users are grouped according to user behaviors, personal basic information, and the like, so as to affect a user behavior by using different strategies and providing different types of information for different users.

It also can be known with reference to FIG. 2 that steps S30 to S70 in the foregoing embodiment of this application are core content of the present disclosure. After a user group (for example, a follower user group of a microblog) is determined, push information such as a push primary account number, an advertisement pushing time period, and an advertising copy of an advertisement task is obtained, then task data is formed, and then the task data of the advertisement is added for each follower user. If there is no advertisement task, an advertisement task may be created, and information of the advertisement task, for example, an advertisement delivery strategy, may be saved. At the same, a microblog pulling request of a user is received, and an advertisement message is provided for the online user according to the strategy.

Therefore, after a user in the user group logs in to the social networking platform, the strategy delivery module of the system accesses a delivery advertisement task list of the user, returns an advertisement which the user is most interested in, and finally marks the advertisement task list as read. It needs to be noted herein that when the delivery advertisement task list of the user is accessed, tasks are sorted according to interest intensity weights of the tasks, and this function is described in detail in the following.

In the foregoing embodiment of this application, a target group of a current delivery task that needs to be pushed is determined, so that the delivery task is pushed in a targeted manner. Because each delivery task in a task database is targeted at a corresponding user group, users in user groups corresponding to different delivery tasks may overlap, that is, a user A may receive two or more delivery tasks at the same time, so that a delivery task received by each user is more accurate.

Preferably, in an optional embodiment provided by this application, after step S50 of adding the delivery task and the task data of the delivery task to a delivery task list for each user included in the user group is performed, a task weight value corresponding to the delivery task may be added, so that before any user in the user group logs in to the social networking platform in step S70, all delivery tasks corresponding to the user in the user group, task data of the delivery tasks, and a task weight value corresponding to each delivery task may be obtained.

It needs to be noted herein that the added task weight value of the delivery task refers to a weight of interest of the user in the delivery task.

It can be known from the foregoing that on condition that the task weight value corresponding to the delivery task is further added after the delivery task and the task data of the delivery task are added for each user, the solution of accessing the delivery task list and pushing the task data of the delivery task to the user in step S70 in Embodiment 1 may be implemented through the following steps:

Step S701: Access the delivery task list, and obtain all delivery tasks corresponding to the user, task data of the delivery tasks, and a task weight value corresponding to each delivery task.

Step S702: Sort the delivery tasks according to the task weight value corresponding to each delivery task, to obtain a delivery task set after sorting.

Step S703: Screen the delivery task set according to a preset threshold, and push a delivery task obtained through screening to the user.

It can be known with reference to FIG. 2 that in step S701 to step S703, after obtaining the user group through screening, the strategy delivery module adds, for each user in the user group, the delivery task (for example, an advertisement) and an intensity weight of interest of the user in the delivery task to a delivery task list (for example, a delivery advertisement task list) of the user. In this case, a new to-be-promoted advertisement is added for the user. The delivery task list in the foregoing embodiment of this application may include data sections such as a task delivery ID, a task weight value, and task delivery time.

It can be known that the foregoing solution provided in Embodiment 1 is applied in the example of promoting an advertisement in a microblog, and the foregoing architecture design implements accurate pushing of the advertisement in the microblog. A follower sub-circle module obtains an advertisement task from a task database, obtains follower users that meet a requirement through screening according to a property of the advertisement, and pushes these follower users to a strategy delivery module. Finally, the strategy delivery module pushes the advertisement to an online user.

In a preferred solution of the foregoing embodiment of this application, after step S70 of accessing the delivery task list and pushing the task data of the delivery task to the user is performed, the following implementation step, which is step S90 including step S901a and step S901b, may be further performed.

Step S901a: Calculate an impression rate of the delivery task according to statistics, and stop pushing the task data of the delivery task if the impression rate of the delivery task is less than a preset impression ratio.

Step S902a: Record a user activity degree of the social networking platform after the impression rate of the delivery task is calculated according to statistics; calculate an average impression rate and a user average activity degree of the delivery task within a predetermined time period; and stop pushing the task data of the delivery task if the average impression rate of the delivery task is less than the user average activity degree.

In steps S901a and S902a, the impression rate and a recent user activity degree of an entire microblog platform are compared to determine whether pushing of the delivery task should be stopped, where the activity degree is calculated by the hour according to statistics, that is, a quantity of people active in the microblog/a quantity of people registering in the microblog within each hour. An average impression rate of an advertisement within a grayscale time period is compared with an average activity degree of a microblog. If the average impression rate is less than the user average activity degree of the platform, an effect control module stops advertising, and delivers the advertisement again by using a primary account number with a higher activity degree.

In another preferred solution of the foregoing embodiment of this application, after step S70 of accessing the delivery task list and pushing the task data of the delivery task to the user is performed, the following implementation steps may be further performed.

Step S901b: Calculate a click-through rate of the delivery task according to statistics, and feed back click-through rate alarm information to an advertisement pusher if the click-through rate of the delivery task is less than a historical click-through rate, or continue pushing the task data of the delivery task to the user if the click-through rate of the delivery task is not less than a historical click-through rate; and/or

Step S901c: Calculate a positive feedback rate of the delivery task according to statistics, and feed back positive feedback rate alarm information to an advertisement pusher if the positive feedback rate of the delivery task is less than a historical positive feedback rate, or continue pushing the task data of the delivery task to the user if the positive feedback rate of the delivery task is not less than a historical positive feedback rate.

The foregoing three solutions provided in step S90, step S901b, and step S901c may be implemented by an effect control module in FIG. 2, so as to provide a user with a delivery task (for example, an advertisement) that has high quality after continuous optimization. The core is adding of an effect statistical module, so that historical delivery profit data is analyzed, and a corresponding effect of advertisements of a certain type is obtained through sorting; and a strategy delivery module provides guidance for advertisement delivery according to the effect data. The new architecture adds a new to-be-delivered advertisement through grayscale, thereby implementing overall control of an advertising effect.

It can be known that according to the present disclosure, an advertising effect (including a delivery rate, a click-through rate, a positive feedback rate, and the like of an advertisement) needs to be first fed back before a delivery task is pushed, and an advertisement delivering manner is adjusted according to the feedback. In this way, a better promotion effect is achieved for an advertiser, and an advertisement that is more meaningful to a user is pushed, so as to provide pleasant content for the user.

The present disclosure relates to computer software and Internet technologies, and is directed at massive data services and the network communications field. A grayscale delivery manner in which an advertisement expectation is met is implemented for a targeted advertisement delivery system. In the targeted advertisement delivery system using a grayscale strategy, portrait data of a user (information about interests and hobbies of a user) is introduced, an advertisement which the user is interested in is returned, and a specified idol of the user is used to push the advertisement message. Besides, in order to achieve a certain advertising effect, some users obtain the advertisement first during delivery, and statistical effect data is analyzed, and if the effect data is lower than an expectation, a target group, an advertising copy, or the like needs to be adjusted, so as to achieve best quality.

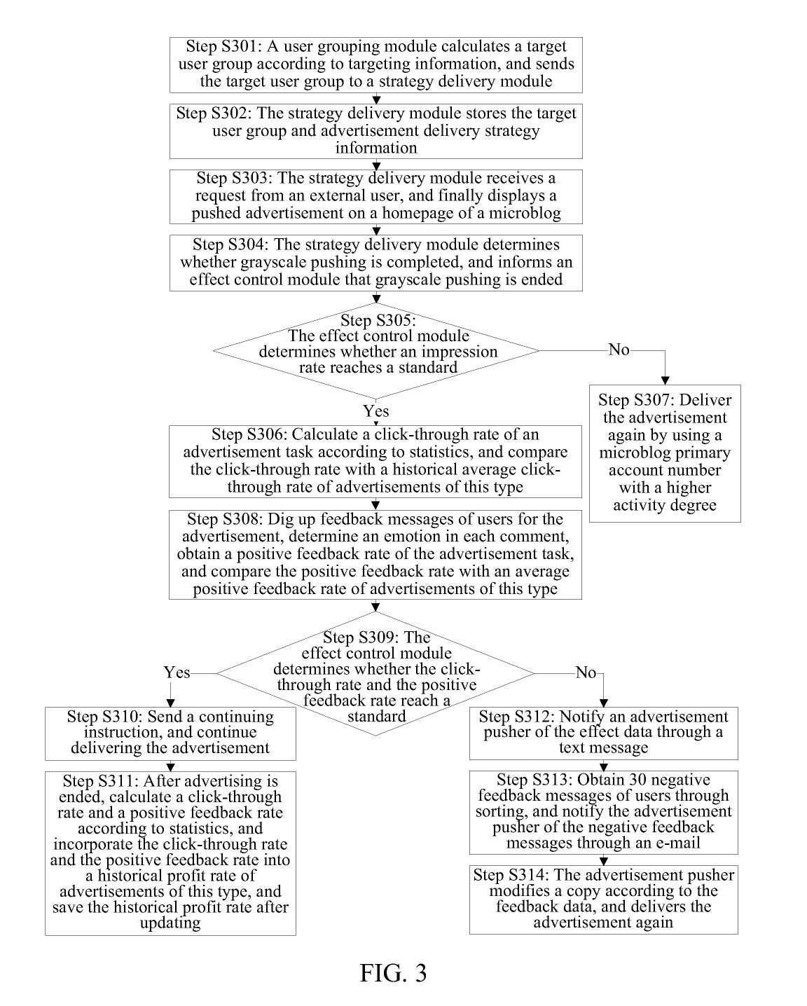

With reference to FIG. 3, still using targeted pushing of an advertisement in a microblog as an example, a preferred solution provided in Embodiment 1 of this application is further described in the following through the example.

Step S301: A user grouping module obtains a delivery task from a task database, and at this time, may perform matching calculation according to targeting information of the delivery task, to determine a user group to which the delivery task is to be delivered in a targeted manner, and send the target user group (a follower list of a microblog user) and a task weight value (that is, an interest weight value) corresponding to each user in the user group of the delivery task to a strategy delivery module.

In an optional solution, in a case in which the delivery task is an advertisement task, related targeting information, which may be obtained by the user grouping module in this step, of the advertisement task may include a push primary account number, characteristics of people for advertising promotion, and the like. Microblog followers are matched according to the targeting information, and followers that meet a requirement are obtained through matching calculation. Further, the followers obtained through matching may be filtered according to interest weights of the followers. A user of which an interest weight is greater than a preset threshold may be obtained as a member of a user group, and a follower list formed by the user group is sent to the strategy delivery module.

Step S302: The strategy delivery module stores the target user group and advertisement delivery strategy information.

In this step, after obtaining the follower list, the strategy delivery module continues to obtain promotion information such as a push primary account number, an advertisement pushing time period, and an advertising copy of the advertisement task, thereby forming task data. Further, for each follower in the user group, the advertisement task may be added to a delivery advertisement task list of the user, and a task weight value of the advertisement task is set. In this case, a new to-be-promoted advertisement is added for the user.

Step S303: The strategy delivery module receives a request from an external user, and finally displays a pushed advertisement, for example, an advertisement pushed by using a specified primary account number (such as an ID number or a microblog name of a microblog of a star), on a homepage of a microblog.

It needs to be noted herein that after a user logs in to a social networking platform, the strategy delivery module receives a request from the external user; in this case, the strategy delivery module accesses a delivery advertisement task list of the user, to return all advertisement tasks pushed to the login user; further, before pushing, the strategy delivery module may sort advertisement tasks according to task weight values of the advertisement tasks, so as to further determine, according to the task weight values, at least one advertisement which the current login user is most interested in, and return the advertisement which the login user is most interested in. At the same time, the advertisement task list of the user needs to be marked as read.

The at least one advertisement which the current login user is most interested may be determined according to the task weight values in the following manners: optionally, several advertisement tasks having the highest task weight values may be selected and fed back as a result; optionally, selection may be performed according to a push percentage, for example, 10% of the advertisement tasks are selected and fed back as a result.

Step S304: The strategy delivery module determines whether grayscale pushing is completed, and informs an effect control module that grayscale pushing is ended. In this case, pushing of the advertisement may be suspended.

In a process of performing the foregoing step, the strategy delivery module may calculate a quantity of people to which the advertisement task is already pushed and a push duration according to statistics. If a specified grayscale proportion, which is usually set to 10%, is reached, that is, the advertisement task is pushed to 10% of people of a target quantity or is pushed for 10% of a target delivery duration, the strategy delivery module sends a grayscale pushing completion notification to an effect statistical module, automatically suspends advertising, and starts an effect control module.

The effect control module receives the grayscale pushing completion notification, and starts to calculate and analyze effect data including an impression rate, a click-through rate, and a positive feedback rate of the pushed advertisement according to statistics. The impression rate is a quantity of impressed people/a quantity of target people for delivery, the click-through rate is a quantity of clicked advertising links/a quantity of impressed people, and the positive feedback rate is a quantity of positive feedback messages for the advertisement/a quantity of feedback messages for the advertisement.

Step S305: The effect control module determines whether an impression rate reaches a standard, that is, determines whether an impression rate of the advertisement task is less than a preset impression ratio. If the impression rate of the delivery task is less than the preset impression ratio, pushing of the task data of the delivery task is stopped, and step S307 is performed; or if the impression rate of the delivery task is not less than the preset impression ratio, step S306 is performed.

It needs to be further noted that step S305 of determining whether a standard is reached may be implemented by comparing the impression rate with a recent user activity degree of an entire microblog platform, where the activity degree is calculated by the hour according to statistics, that is, a quantity of people active in the microblog/a quantity of people registering in the microblog within each hour. An average impression rate of an advertisement within a grayscale time period is compared with an average activity degree of a microblog. If the average impression rate is less than the activity degree of the platform, an effect control module stops advertising, and delivers the advertisement again by using a primary account number with a higher activity degree.

Step S306: Calculate a click-through rate of the advertisement task according to statistics, and compare the click-through rate with a historical average click-through rate of advertisements of this type. If the click-through rate of the advertisement task is less than the historical average click-through rate, alarm notification information is sent; or if the click-through rate of the advertisement task is not less than the historical average click-through rate, step S308 is performed.

In the foregoing step, the effect control module may save a historical average click-through rate of each type of advertisements.

Step S307: Deliver the advertisement again by using a microblog primary account number with a higher activity degree.

Step S308: Dig up feedback messages of users for the advertisement, determine an emotion in each comment, obtain a positive feedback rate of the advertisement task, and compare the positive feedback rate with an average positive feedback rate of advertisements of this type.

It needs to be noted herein that the effect control module may save a historical average positive feedback rate of each type of advertisements at the same time. The positive feedback rate is obtained by digging up feedback messages of users for the advertisement message. For example, a keyword or character in a feedback message may be selected through screening to determine whether the message is positive feedback or negative feedback. That is, an emotion, that is, positive feedback or negative feedback, in each feedback message is determined according to a word.

Step S309: The effect control module determines whether the click-through rate and the positive feedback rate reach a standard through the this step. Step S310 is performed if the standard is reached, or step S312 is performed if the standard is not reached.

Step S310: Send a continuing instruction, and continue delivering the advertisement.

Step S311: After advertising is ended, calculate a click-through rate and a positive feedback rate according to statistics, and incorporate the click-through rate and the positive feedback rate into a historical profit rate of advertisements of this type, and save the historical profit rate after updating.

Step S312: Notify an advertisement pusher through a text message, and send the effect data to the advertisement pusher.

Step S313: Feedback information may be sent to the advertisement pusher. For example, obtain 30 negative feedback messages of users through sorting, and notify the advertisement pusher of the negative feedback messages through an e-mail.

Step S314: The advertisement pusher modifies a copy according to the feedback data, and delivers the advertisement again.

It can be known from the foregoing that if a click-through rate or a positive feedback rate is less than a historical expected rate, the effect control module in the foregoing solution sends the click-through rate and the positive feedback rate of a delivered advertisement and historical data of the same type to an advertisement pusher through a text message. In addition, the effect control module obtains 30 negative feedback messages of users through sorting, and sends the negative feedback messages to the advertisement pusher through an e-mail, so that the advertisement pusher adjusts an advertising copy and the like according to the data and delivers the advertisement again. If all advertisement profit data meets expectations, the effect control module sends a continuing instruction to the strategy delivery module, so that the advertisement task is performed according to an original strategy. Besides, when advertisement delivery is ended, the effect control module obtains a click-through rate and a positive feedback rate, incorporates the click-through rate and the positive feedback rate into original historical data of advertisements of this type, to obtain a historical average click-through rate and average positive feedback rate, and saves the historical average click-through rate and average positive feedback rate after updating.

It can be known that the foregoing solution provided by the foregoing embodiment of this application increases control over an advertisement. In the promotion system for advertisement delivery shown in FIG. 3, a concept of grayscale is introduced to implement warm-up delivery at an early stage of advertising, to ensure that advertising is launched on the premise of specified expected profits. Therefore, an operation capability is improved. Because a statistics analyzing module is introduced to analyze advertisement data, profits that should be gained of each type of advertisements are obtained. By analyzing the statistical data, an expectation of advertisement delivery from users can be formed. The statistics analyzing module interacts with a strategy delivery module, to provide guidance for normal advertising.

It needs to be noted that the foregoing method embodiments are described as a series of action combinations for ease of description, but a person skilled in the art should know that the present disclosure is not limited to the described order of the actions because some steps may be performed in another order or simultaneously according to the present disclosure. Besides, a person skilled in the art should also know that the embodiments described in this specification are all preferred embodiments, and a related action and module may not be essential to the present disclosure.

Through the foregoing description of the implementation manners, a person skilled in the art may clearly understand that the method in the foregoing embodiments may be implemented by using software plus a necessary universal hardware platform, and certainly may also be implemented by using hardware, but the former is a preferred implementation manner in most cases. Based on such an understanding, the technical solutions of the present disclosure essentially, or the part contributing to the existing technology, may be embodied in the form of a software product. The computer software product is stored in a computer readable storage medium (such as a ROM/RAM, a magnetic disk, or an optical disc), and includes several instructions for instructing a terminal device (which may be a mobile phone, a computer, a server, or a network device) to execute the method described in the embodiments of the present invention.

### Embodiment 2

In this application, a suitable computing architecture that can be used to implement the principle of this application may be described with reference to the drawings. In the following description, unless specified otherwise, embodiments of this application are described with reference to numerals of actions and operations executed by one or more computers. Therefore, it can be understood that sometimes these actions and operations executed by a computer include manipulation of an electrical signal of data presented in a structural form by a processing unit of the computer. The manipulation converts the data or maintains the data in a position in a memory system of the computer, and this reconfigures or changes the operations of the computer in a manner that is understood by all persons skilled in the art. A data structure of the data is maintained in a physical position of a memory having a specific attribute defined in a data format. However, although this application is described in the foregoing context, it does not mean that the context is restrictive; as is understood by a person skilled in the art, various aspects of the actions and operations described in the following may also be implemented by using hardware.

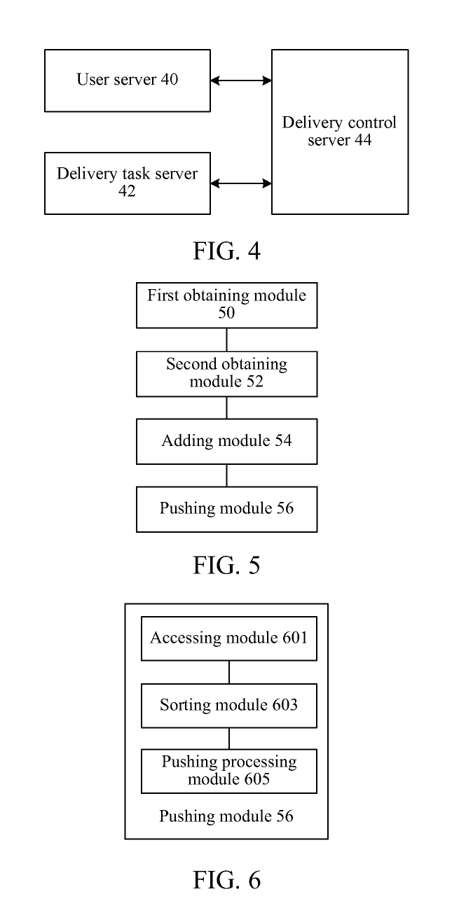

In a most basic configuration, FIG. 4 is a schematic structural diagram of a system for controlling a delivery task in a social networking platform according to Embodiment 2 of the present invention. For ease of description, the drawn system structure is merely an example of a suitable environment, and is not a limitation on the use scope or function of this application.

As shown in FIG. 4, the system may include: a user server 40, a delivery task server 42, and a delivery control server 44.

The user server 40 is configured to save a user group to which a delivery task is to be released in a targeted manner, the user group including one or more users, and the user server determining the user group, to which the delivery task is to be released in a targeted manner, according to targeting information and/or a user characteristic weight value, which are recorded in a task database, of the delivery task.

The delivery task server 42 is configured to save task data of the delivery task.

The delivery control server 44 has a communication relationship with the user server and the delivery task server, and is configured to add the delivery task and the task data of the delivery task to a delivery task list for each user included in the user group after the user group to which the delivery task is to be released in a targeted manner and the task data of the delivery task are obtained, access the delivery task list after any user in the user group logs in to a social networking platform, and push the task data of the delivery task to the user.

In Embodiment 2 of this application, before a current delivery task is delivered, a user group to which the delivery task needs to be sent in a targeted manner is first determined according to information of the current delivery task, and then the delivery task is added to a task list of a user in the user group. Therefore, once the user in the user group logs in, a system automatically pushes the delivery task according to a record in the delivery task list. It can be known that the delivery task pushed on a current social networking platform is pushed to the corresponding user group in a targeted manner. It is noticeable that because the target user group is obtained through screening according to targeting information and/or a user characteristic weight value, which are recorded in a task database, of the delivery task, the current delivery task is accurately pushed to the matching user group, and users in the user group do not change dynamically. Therefore, by using the solution provided by this embodiment of the present invention, potential information of users in a social networking platform is dug up, so as to predict a user to which a current delivery task needs to be pushed. Such a manner for accurately pushing a delivery task implements accurate targeted pushing of a delivery task, thereby preventing a waste of resources of the delivery task. In addition, for a user receiving the delivery task, the obtained delivery task is content that satisfies a need of the user. Therefore, a technical problem of inaccurate pushing of a delivery task in a social networking platform in the existing technology is solved, and accurate targeted pushing of a delivery task is implemented.

The solution of the system provided by the foregoing embodiment of this application may be run on a social networking platform server. For optional or preferred embodiments provided by the present disclosure, the embodiments may be further described in detail by using targeted pushing of an advertisement in a microblog as an example. In this case, the social networking platform may be a microblog; the delivery task may be an advertisement; the task data may be advertisement task information that is already saved, and may include a delivery time period and a delivering terminal of a delivery object and a quantity of people to which the delivery object is already delivered; and the delivery task list may be an advertisement task list, and is used to save delivery data of each user in a user group, that is, an advertising link that should be delivered to a user.

In the foregoing system embodiment of this application, the solution of determining the user group, to which the delivery task is to be released in a targeted manner, according to targeting information and/or a user characteristic weight value, which are recorded in a task database, of the delivery task may be implemented in the following manners:

The first manner: First obtain the targeting information of the delivery task from the task database, where the targeting information includes characteristic information of a delivery object; and then perform matching processing in a user group information base according to the characteristic information of the delivery object, and obtain a first user group having the characteristic information of the delivery object, where the first user group having the characteristic information of the delivery object forms the user group to which the delivery task is to be released in a targeted manner.

The foregoing solution provided by an optional embodiment implements accurate screening of a push target of the delivery task that needs to be pushed currently, and the task database may be built on a task server that runs independently. In an application scenario in which a microblog is used as an example, an advertisement task may be first obtained from a list in an advertisement task database; at the same time, a follower sub-circle (a friend group of a microblog user) obtains related targeting information, such as a push primary account number and characteristics of people for advertising promotion (for example, professions of users), of the advertisement task; and followers that meet a requirement are obtained through calculation. In this way, according to a characteristic of push target users required by advertising promotion, a group of users that meet the characteristic are selected from chosen microblog primary account numbers, thereby obtaining a user group (a follower group of a microblog) for targeted advertisement pushing.

The second manner: First obtain the targeting information of the delivery task from the task database, where the targeting information includes characteristic information of a delivery object; then perform matching processing in a user group information base according to the characteristic information of the delivery object, and obtain a first user group having the characteristic information of the delivery object; then sort users in the first user group according to characteristic weight values of the users; and finally select a user of which a characteristic weight value is greater than a preset threshold from the first user group, to generate the user group to which the delivery task is to be released in a targeted manner.

The foregoing solution provided by another optional embodiment also implements accurate screening of a push target of the delivery task that needs to be pushed currently. Compared with the first manner, the second manner further limits a screening condition, and the screen condition not only includes targeting information of an advertisement task but also includes a user characteristic weight value. In this way, a quantity of users receiving a pushed advertisement is further limited, so that the current advertisement is pushed accurately and efficiently. It can be known through the foregoing analysis that in the foregoing two optional embodiments, users are grouped according to user behaviors, personal basic information, and the like, so as to affect a user behavior by using different strategies and providing different types of information for different users.

In the foregoing embodiment of this application, a target group of a current delivery task that needs to be pushed is determined, so that the delivery task is pushed in a targeted manner. Because each delivery task in a task database is targeted at a corresponding user group, users in user groups corresponding to different delivery tasks may overlap, that is, a user A may receive two or more delivery tasks at the same time. In order to make a delivery task received by each user more accurate, in an optional embodiment provided by this application, after the delivery task and the task data of the delivery task are added to the delivery task list for each user included in the user group, a task weight value corresponding to the delivery task may be added, so that before any user in the user group logs in to the social networking platform, all delivery tasks corresponding to the user in the user group, task data of the delivery tasks, and a task weight value corresponding to each delivery task may be obtained.

It can be known from the foregoing that on condition that the task weight value corresponding to the delivery task is further added after the delivery task and the task data of the delivery task are added for each user, the solution of accessing the delivery task list and pushing the task data of the delivery task to the user in Embodiment 2 may be implemented through the following steps:

Step S701: Access the delivery task list, and obtain all delivery tasks corresponding to the user, task data of the delivery tasks, and a task weight value corresponding to each delivery task.

Step S702: Sort the delivery tasks according to the task weight value corresponding to each delivery task, to obtain a delivery task set after sorting.

Step S703: Screen the delivery task set according to a preset threshold, and push a delivery task obtained through screening to the user.

In the foregoing solution, after the user group is obtained through screening, for each user in the user group, the delivery task (for example, an advertisement) and an intensity weight of interest of the user in the delivery task are added to a delivery task list (for example, a delivery advertisement task list) of the user. In this case, a new to-be-promoted advertisement is added for the user. The delivery task list in the foregoing embodiment of this application may include data sections such as a task delivery ID, a task weight value, and task delivery time.

It can be known that the foregoing solution provided in Embodiment 2 is applied in the example of promoting an advertisement in a microblog, and the foregoing architecture design implements accurate pushing of the advertisement in the microblog. A follower sub-circle module obtains an advertisement task from a task database, obtains follower users that meet a requirement through screening according to a property of the advertisement, and pushes these follower users to a strategy delivery module. Finally, the strategy delivery module pushes the advertisement to an online user.

In a preferred solution of Embodiment 2 of this application, after the delivery task list is accessed and the task data of the delivery task is pushed to the user, the following implementation solutions may be further executed.

An impression rate of the delivery task is first calculated according to statistics, and pushing of the task data of the delivery task is stopped if the impression rate of the delivery task is less than a preset impression ratio.

A user activity degree of the social networking platform is then recorded after the impression rate of the delivery task is calculated according to statistics; an average impression rate and a user average activity degree of the delivery task within a predetermined time period are calculated; and pushing of the task data of the delivery task is stopped if the average impression rate of the delivery task is less than the user average activity degree.

In the foregoing solution, the impression rate and a recent user activity degree of an entire microblog platform are compared to determine whether pushing of the delivery task should be stopped, where the activity degree is calculated by the hour according to statistics, that is, a quantity of people active in the microblog/a quantity of people registering in the microblog within each hour. An average impression rate of an advertisement within a grayscale time period is compared with an average activity degree of a microblog. If the average impression rate is less than the user average activity degree of the platform, an effect control module stops advertising, and delivers the advertisement again by using a primary account number with a higher activity degree.

In another preferred solution of the foregoing embodiment of this application, after the delivery task list is accessed and the task data of the delivery task is pushed to the user, the following implementation solutions may be further executed.

In an optional solution, a click-through rate of the delivery task needs to be calculated according to statistics, and click-through rate alarm information is fed back to an advertisement pusher if the click-through rate of the delivery task is less than a historical click-through rate, or pushing the task data of the delivery task to the user is continued if the click-through rate of the delivery task is not less than a historical click-through rate.

In another optional solution, a positive feedback rate of the delivery task needs to be calculated according to statistics, and positive feedback rate alarm information is fed back to an advertisement pusher if the positive feedback rate of the delivery task is less than a historical positive feedback rate, or pushing the task data of the delivery task to the user is continued if the positive feedback rate of the delivery task is not less than a historical positive feedback rate.

In the foregoing solutions, a user is provided with a delivery task (for example, an advertisement) that has high quality after continuous optimization. The core is adding of an effect statistical function, so that historical delivery profit data is analyzed, and a corresponding effect of advertisements of a certain type is obtained through sorting; and a strategy delivery module provides guidance for advertisement delivery according to the effect data. The new architecture adds a new to-be-delivered advertisement through grayscale, thereby implementing overall control of an advertising effect.

It can be known that according to the present disclosure, an advertising effect (including a delivery rate, a click-through rate, a positive feedback rate, and the like of an advertisement) needs to be first fed back before a delivery task is pushed, and an advertisement delivering manner is adjusted according to the feedback. In this way, a better promotion effect is achieved for an advertiser, and an advertisement that is more meaningful to a user is pushed, so as to provide pleasant content for the user.

The present disclosure relates to computer software and Internet technologies, and is directed at massive data services and the network communications field. A grayscale delivery manner in which an advertisement expectation is met is implemented for a targeted advertisement delivery system. In the targeted advertisement delivery system using a grayscale strategy, portrait data of a user (information about interests and hobbies of a user) is introduced, an advertisement which the user is interested in is returned, and a specified idol of the user is used to push the advertisement message. Besides, in order to achieve a certain advertising effect, some users obtain the advertisement first during delivery, and statistical effect data is analyzed, and if the effect data is lower than an expectation, a target group, an advertising copy, or the like needs to be adjusted, so as to achieve best quality.

It should be further noted herein that optional or preferred solutions of the system embodiment provided in Embodiment 2 of this application are the same as those of the method embodiment in Embodiment 1, but are not limited to the implementation manners of the method in Embodiment 1.

### Embodiment 3

According to an embodiment of the present invention, an apparatus embodiment used to implement the foregoing method embodiment is further provided. In a most basic configuration, FIG. 5 is a schematic structural diagram of an apparatus for controlling a delivery task in a social networking platform according to Embodiment 3 of the present invention. For ease of description, the drawn system structure is merely an example of a suitable environment, and is not a limitation on the use scope or function of this application. Any component or combination of components shown in FIG. 5 shall not be explained as essential or necessary to the computer system.

The apparatus provided by the foregoing embodiment of this application may run at a server end.

As shown in FIG. 5, the apparatus may include: a first obtaining module 50, a second obtaining module 52, an adding module 54, and a pushing module 56.

The first obtaining module 50 is configured to obtain a user group to which a delivery task is to be released in a targeted manner, the user group including one or more users, and the user group to which the delivery task is to be released in a targeted manner being determined according to targeting information and/or a user characteristic weight value, which are recorded in a task database, of the delivery task; the second obtaining module 52 is configured to obtain task data of the delivery task; the adding module 54 is configured to add the delivery task and the task data of the delivery task to a delivery task list for each user included in the user group; and the pushing module 56 is configured to access the delivery task list after any user in the user group logs in to a social networking platform, and push the task data of the delivery task to the user.

In Embodiment 3 of this application, before a current delivery task is delivered, a user group to which the delivery task needs to be sent in a targeted manner is first determined according to information of the current delivery task, and then the delivery task is added to a task list of a user in the user group. Therefore, once the user in the user group logs in, a system automatically pushes the delivery task according to a record in the delivery task list. It can be known that the delivery task pushed on a current social networking platform is pushed to the corresponding user group in a targeted manner. It is noticeable that because the target user group is obtained through screening according to targeting information and/or a user characteristic weight value, which are recorded in a task database, of the delivery task, the current delivery task is accurately pushed to the matching user group, and users in the user group do not change dynamically. Therefore, by using the solution provided by this embodiment of the present invention, potential information of users in a social networking platform is dug up, so as to predict a user to which a current delivery task needs to be pushed. Such a manner for accurately pushing a delivery task implements accurate targeted pushing of a delivery task, thereby preventing a waste of resources of the delivery task. In addition, for a user receiving the delivery task, the obtained delivery task is content that satisfies a need of the user. Therefore, a technical problem of inaccurate pushing of a delivery task in a social networking platform in the existing technology is solved, and accurate targeted pushing of a delivery task is implemented.

It needs to be noted herein that the first obtaining module 50, the second obtaining module 52, the adding module 54, and the pushing module 56 are corresponding to step S10 to step S70 in Embodiment 1. An implementation example and an application scenario of the four modules are the same as those of the corresponding steps, but are not limited to the content disclosed in Embodiment 1. It needs to be further noted that the first obtaining module 50, the second obtaining module 52, the adding module 54, and the pushing module 56 may be saved in a memory, or may run in a processor having a processing function.

It needs to be further noted herein that the apparatus provide in the foregoing embodiment of this application may run on a social networking platform server. For optional or preferred embodiments provided by the present disclosure, the embodiments may be further described in detail by using targeted pushing of an advertisement in a microblog as an example. In this case, the social networking platform may be a microblog; the delivery task may be an advertisement; the task data may be advertisement task information that is already saved, and may include a delivery time period and a delivering terminal of a delivery object and a quantity of people to which the delivery object is already delivered; and the delivery task list may be an advertisement task list, and is used to save delivery data of each user in a user group, that is, an advertising link that should be delivered to a user.

Preferably, in the apparatus, after the function of the adding module 54 is performed, a function of the following increasing module 58 may be performed; and before the pushing module 56 is executed, the following third obtaining module 55 may be executed.

The increasing module 58 is configured to add a task weight value corresponding to the delivery task; and the third obtaining module 55 is configured to obtain all delivery tasks corresponding to the user in the user group, task data of the delivery tasks, and a task weight value corresponding to each delivery task.

As shown in FIG. 6, the pushing module 56 in Embodiment 3 of this application may include: an accessing module 601, a sorting module 603, and a pushing processing module 605.

The accessing module 601 is configured to access the delivery task list, and obtain all delivery tasks corresponding to the user, task data of the delivery tasks, and a task weight value corresponding to each delivery task; the sorting module 603 is configured to sort the delivery tasks according to the task weight value corresponding to each delivery task, to obtain a delivery task set after sorting; and the pushing processing module 605 is configured to screen the delivery task set according to a preset threshold, and push a delivery task obtained through screening to the user.

It needs to be noted herein that the accessing module 601, the sorting module 603, and the pushing processing module 605 are corresponding to step S701 to step S703 in Embodiment 1. An implementation example and an application scenario of the three modules are the same as those of the corresponding steps, but are not limited to the content disclosed in Embodiment 1. It needs to be further noted that the accessing module 601, the sorting module 603, and the pushing processing module 605 may be saved in a memory, or may run in a processor having a processing function.

In the foregoing embodiment, the step of determining the user group, to which the delivery task is to be released in a targeted manner, according to targeting information and/or a user characteristic weight value, which are recorded in a task database, of the delivery task may be implemented through the following solution of: first obtaining the targeting information of the delivery task from the task database, where the targeting information includes characteristic information of a delivery object; and then performing matching processing in a user group information base according to the characteristic information of the delivery object, and obtaining a first user group having the characteristic information of the delivery object, where the first user group having the characteristic information of the delivery object forms the user group to which the delivery task is to be released in a targeted manner; or may be implemented through the solution of: first obtaining the targeting information of the delivery task from the task database, where the targeting information includes characteristic information of a delivery object; then performing matching processing in a user group information base according to the characteristic information of the delivery object, and obtaining a first user group having the characteristic information of the delivery object; then sorting users in the first user group according to characteristic weight values of the users; and finally selecting a user of which a characteristic weight value is greater than a preset threshold from the first user group, to generate the user group to which the delivery task is to be released in a targeted manner.

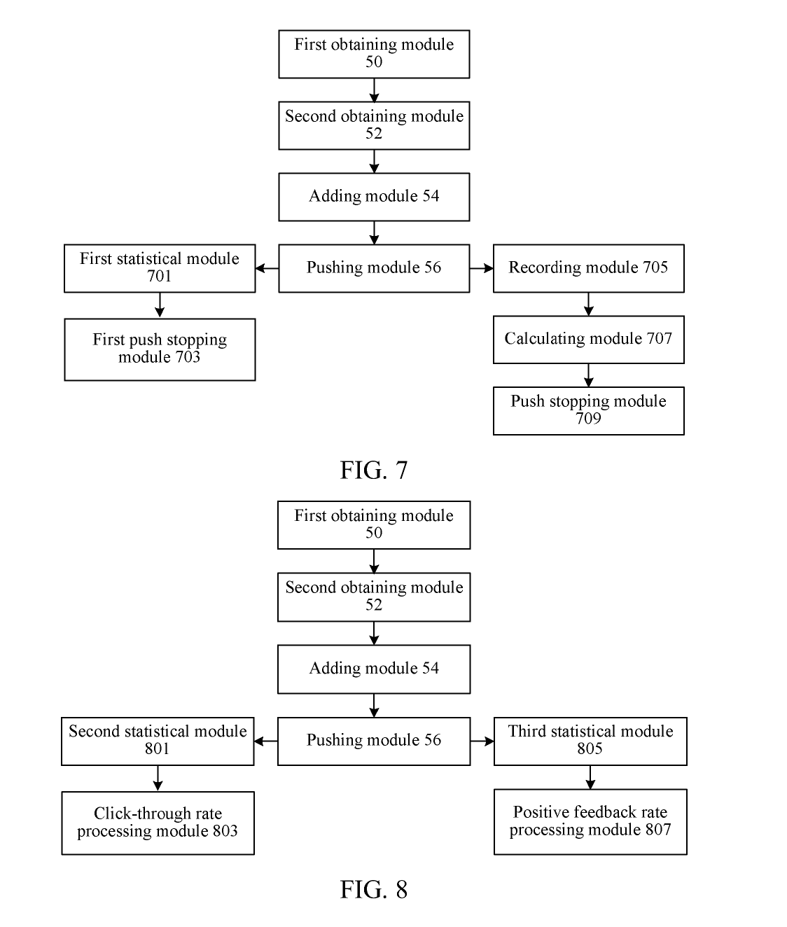

As shown in FIG. 7, in the foregoing embodiment of this application, after the function of the pushing module 56 is performed, the apparatus may execute the following functional modules: a first statistical module 701 and a first push stopping module 703, or may execute the following functional modules: a recording module 705, a calculating module 707, and a push stopping module 709.

The first statistical module 701 is configured to calculate an impression rate of the delivery task according to statistics, and the first push stopping module 703 is configured to stop pushing the task data of the delivery task if the impression rate of the delivery task is less than a preset impression ratio.

The recording module 705 is configured to record a user activity degree of the social networking platform; the calculating module 707 is configured to calculate an average impression rate and a user average activity degree of the delivery task within a predetermined time period; and the push stopping module 709 is configured to stop pushing the task data of the delivery task if the average impression rate of the delivery task is less than the user average activity degree.

It needs to be noted herein that an apparatus module including the first statistical module 701 and the first push stopping module 703 and an apparatus module including the recording module 705, the calculating module 707, and the push stopping module 709 are respectively corresponding to step S901a and step S902a in Embodiment 1. An implementation example and an application scenario of the five modules are the same as those of the corresponding steps, but are not limited to the content disclosed in Embodiment 1. It needs to be further noted that the first statistical module 701, the first push stopping module 703, the recording module 705, the calculating module 707, and the push stopping module 709 may be saved in a memory, or may run in a processor having a processing function.

As shown in FIG. 8, in the foregoing embodiment of this application, after the function of the pushing module 56 is performed, the apparatus may further execute the following functional modules: a second statistical module 801, a click-through rate processing module 803, and/or a third statistical module 805 and a positive feedback rate processing module 807.

The second statistical module 801 is configured to calculate a click-through rate of the delivery task according to statistics, and the click-through rate processing module 803 is configured to feed back click-through rate alarm information if the click-through rate of the delivery task is less than a historical click-through rate, or continue pushing the task data of the delivery task to the user if the click-through rate of the delivery task is not less than a historical click-through rate.

The third statistical module 805 is configured to calculate a positive feedback rate of the delivery task according to statistics, and the positive feedback rate processing module 807 is configured to feed back positive feedback rate alarm information if the positive feedback rate of the delivery task is less than a historical positive feedback rate, or continue pushing the task data of the delivery task to the user if the positive feedback rate of the delivery task is not less than a historical positive feedback rate.

It needs to be noted herein that an apparatus module including the second statistical module 801 and the click-through rate processing module 803 and an apparatus module including the third statistical module 805 and the positive feedback rate processing module 807 are respectively corresponding to step S901b and step S901c in Embodiment 1. An implementation example and an application scenario of the four modules are the same as those of the corresponding steps, but are not limited to the content disclosed in Embodiment 1. It needs to be further noted that the second statistical module 801, the click-through rate processing module 803, the third statistical module 805, and the positive feedback rate processing module 807 may be saved in a memory, or may run in a processor having a processing function.

It can be seen from the foregoing description that the present disclosure achieves the following technical effects: Such a manner for accurately pushing a delivery task implements accurate targeted pushing of a delivery task, thereby preventing a waste of resources of the delivery task. In addition, for a user receiving the delivery task, the obtained delivery task is content that satisfies a need of the user. Therefore, a technical problem of inaccurate pushing of a delivery task in a social networking platform in the existing technology is solved, and accurate targeted pushing of a delivery task is implemented.

The sequence numbers of the foregoing embodiments of the present invention are merely for the convenience of description, and do not imply the preference among the embodiments.

In the foregoing embodiments of the present invention, the description of the embodiments each has a focus. For a part that is not described in detail of an embodiment, reference may be made to a related description of another embodiment.

In the embodiments provided in this application, it should be understood that the disclosed server end may be implemented in another manner. The described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, the functional units in the embodiments of the present invention may be integrated into one processing unit, or each of the units may exist alone physically, or two or more units may be integrated into one unit. The integrated unit may be implemented in the form of hardware, or may be implemented in the form of a software functional unit.

When the integrated unit is implemented in a form of a software functional unit and sold or used as an independent product, the integrated unit may be stored in a computer-readable storage medium. Based on such an understanding, the technical solutions of the present invention essentially, or the part contributing to the existing technology, or all or a part of the technical solutions may be implemented in a form of a software product. The computer software product is stored in a storage medium and includes several instructions for instructing a computer device (which may be a personal computer, a server, a network device, or the like) to perform all or a part of the steps of the methods described in the embodiments of the present invention. The foregoing storage medium includes various mediums that can store program code, such as a USB flash drive, a ROM, a RAM, a removable hard disk, a magnetic disk, or an optical disc.

The foregoing descriptions are merely specific embodiments of the present invention. It should be noted that a person of ordinary skill in the art may make modifications and variations without departing from the principle of the present disclosure, and these modifications and variations should be construed as falling within the scope of the present invention.

1. A method for controlling a delivery task in a social networking platform, comprising:
obtaining a user group to which a delivery task is to be released in a targeted manner, the user group comprising one or more users, and the user group to which the delivery task is to be released in a targeted manner being determined according to targeting information and/or a user characteristic weight value, which are recorded in a task database, of the delivery task;
obtaining task data of the delivery task;
adding the delivery task and the task data of the delivery task to a delivery task list for each user comprised in the user group; and
accessing the delivery task list after any user in the user group logs in to a social networking platform, and pushing the task data of the delivery task to the user.

2. The method according to claim 1, wherein after the adding the delivery task and the task data of the delivery task to a delivery task list for each user comprised in the user group, the method further comprises: adding a task weight value corresponding to the delivery task, wherein before any user in the user group logs in to the social networking platform, the method further comprises: obtaining all delivery tasks corresponding to the user in the user group, task data of the delivery tasks, and a task weight value corresponding to each delivery task.

3. The method according to claim 2, wherein the step of accessing the delivery task list and pushing the task data of the delivery task to the user comprises:
accessing the delivery task list, and obtaining all delivery tasks corresponding to the user, task data of the delivery tasks, and a task weight value corresponding to each delivery task;
sorting the delivery tasks according to the task weight value corresponding to each delivery task, to obtain a delivery task set after sorting; and
screening the delivery task set according to a preset threshold, and pushing a delivery task obtained through screening to the user.

4. The method according to claim 1, wherein the step of determining the user group, to which the delivery task is to be released in a targeted manner, according to targeting information and/or a user characteristic weight value, which are recorded in a task database, of the delivery task comprises:
obtaining the targeting information of the delivery task from the task database, wherein the targeting information comprises characteristic information of a delivery object; and performing matching processing in a user group information base according to the characteristic information of the delivery object, and obtaining a first user group having the characteristic information of the delivery object, wherein the first user group having the characteristic information of the delivery object forms the user group to which the delivery task is to be released in a targeted manner; or
obtaining the targeting information of the delivery task from the task database, wherein the targeting information comprises characteristic information of a delivery object; performing matching processing in a user group information base according to the characteristic information of the delivery object, and obtaining a first user group having the characteristic information of the delivery object; and selecting a user of which a characteristic weight value is greater than a preset threshold from the first user group, to generate the user group to which the delivery task is to be released in a targeted manner.

5. The method according to claim 1, wherein after the accessing the delivery task list and pushing the task data of the delivery task to the user, the method further comprises:
calculating an impression rate of the delivery task according to statistics, and stopping pushing the task data of the delivery task if the impression rate of the delivery task is less than a preset impression ratio; and
after the calculating an impression rate of the delivery task according to statistics, the method further comprises: recording a user activity degree of the social networking platform; calculating an average impression rate and a user average activity degree of the delivery task within a predetermined time period; and stopping pushing the task data of the delivery task if the average impression rate of the delivery task is less than the user average activity degree.

6. The method according to claim 1, wherein after the accessing the delivery task list and pushing the task data of the delivery task to the user, the method further comprises:
calculating a click-through rate of the delivery task according to statistics, and feeding back click-through rate alarm information if the click-through rate of the delivery task is less than a historical click-through rate, or continuing pushing the task data of the delivery task to the user if the click-through rate of the delivery task is not less than a historical click-through rate; and/or
calculating a positive feedback rate of the delivery task according to statistics, and feeding back positive feedback rate alarm information if the positive feedback rate of the delivery task is less than a historical positive feedback rate, or continuing pushing the task data of the delivery task to the user if the positive feedback rate of the delivery task is not less than a historical positive feedback rate.

7. A system for controlling a delivery task in a social networking platform, comprising:
a user server, configured to save a user group to which a delivery task is to be released in a targeted manner, the user group comprising one or more users, and the user server determining the user group, to which the delivery task is to be released in a targeted manner, according to targeting information and/or a user characteristic weight value, which are recorded in a task database, of the delivery task;
a delivery task server, configured to save task data of the delivery task; and
a delivery control server, having a communication relationship with the user server and the delivery task server, and configured to add the delivery task and the task data of the delivery task to a delivery task list for each user comprised in the user group after the user group to which the delivery task is to be released in a targeted manner and the task data of the delivery task are obtained, access the delivery task list after any user in the user group logs in to a social networking platform, and push the task data of the delivery task to the user.

8. An apparatus for controlling a delivery task in a social networking platform, comprising:
a first obtaining module, configured to obtain a user group to which a delivery task is to be released in a targeted manner, the user group comprising one or more users, and the user group to which the delivery task is to be released in a targeted manner being determined according to targeting information and/or a user characteristic weight value, which are recorded in a task database, of the delivery task;
a second obtaining module, configured to obtain task data of the delivery task;
an adding module, configured to add the delivery task and the task data of the delivery task to a delivery task list for each user comprised in the user group; and
a pushing module, configured to access the delivery task list after any user in the user group logs in to a social networking platform, and push the task data of the delivery task to the user.

9. The apparatus according to claim 8, wherein the apparatus further comprises:
an increasing module, configured to add a task weight value corresponding to the delivery task; and
a third obtaining module, configured to obtain all delivery tasks corresponding to the user in the user group, task data of the delivery tasks, and a task weight value corresponding to each delivery task.

10. The apparatus according to claim 9, wherein the pushing module comprises:
an accessing module, configured to access the delivery task list, and obtain all delivery tasks corresponding to the user, task data of the delivery tasks, and a task weight value corresponding to each delivery task;
a sorting module, configured to sort the delivery tasks according to the task weight value corresponding to each delivery task, to obtain a delivery task set after sorting; and
a pushing processing module, configured to screen the delivery task set according to a preset threshold, and push a delivery task obtained through screening to the user.

11. The apparatus according to claim 8, wherein the apparatus further comprises: a first statistical module and a first push stopping module, wherein the first statistical module is configured to calculate an impression rate of the delivery task according to statistics, and the first push stopping module is configured to stop pushing the task data of the delivery task if the impression rate of the delivery task is less than a preset impression ratio; and
the apparatus further comprises: a recording module, a calculating module, and a second push stopping module, wherein the recording module is configured to record a user activity degree of the social networking platform; the calculating module is configured to calculate an average impression rate and a user average activity degree of the delivery task within a predetermined time period; and the second push stopping module is configured to stop pushing the task data of the delivery task if the average impression rate of the delivery task is less than the user average activity degree.

12. The apparatus according to claim 8, wherein the apparatus further comprises: a second statistical module and a click-through rate processing module, wherein the second statistical module is configured to calculate a click-through rate of the delivery task according to statistics, and the click-through rate processing module is configured to feed back click-through rate alarm information if the click-through rate of the delivery task is less than a historical click-through rate, or continue pushing the task data of the delivery task to the user if the click-through rate of the delivery task is not less than a historical click-through rate; and
the apparatus further comprises: a third statistical module and a positive feedback rate processing module, wherein the third statistical module is configured to calculate a positive feedback rate of the delivery task according to statistics, and the positive feedback rate processing module is configured to feed back positive feedback rate alarm information if the positive feedback rate of the delivery task is less than a historical positive feedback rate, or continue pushing the task data of the delivery task to the user if the positive feedback rate of the delivery task is not less than a historical positive feedback rate.
